(19) United States
(12) Patent Application Publication
(10) Pub. No.: US 2026/0105031 A1
(43) Pub. Date: Apr. 16, 2026

(54) AGGREGATION FUNCTION CONTROL IN DATA MODELING USING ARTIFICIAL INTELLIGENCE

(71) Applicant: MicroStrategy Incorporated, Vienna, VA (US)

(72) Inventors: Witold Tomasz Cichon, Washington, DC (US); Ananya Ojha, Dunn Loring, VA (US); Paramjeet S. Sidhu, Herndon, VA (US); Bikan Tan, Vienna, VA (US); Mohamed Diakite, Vienna, VA (US); Jingbin Zhang, Hangzhou (CN)

(21) Appl. No.: 19/334,404

(22) Filed: Sep. 19, 2025

Related U.S. Application Data
(60) Provisional application No. 63/696,720, filed on Sep. 19, 2024.

(51) Int. Cl. G06F 16/21; G06F 16/242

(52) U.S. Cl. CPC G06F 16/212; G06F 16/244

(57) ABSTRACT

Methods, systems, and apparatus, including computer-readable media, for aggregation function control in data modeling using artificial intelligence. In some implementations, the system stores a data model for one or more data sets, where the data model identifies a set of data objects in the one or more data sets. The system stores a setting for a particular data object specifying whether the data object is aggregatable with respect to a particular dimension. The system receives a user prompt though a chatbot interface, and the system provides a request to one or more artificial intelligence and/or machine learning (AI/ML) models based on the user prompt. The request (i) indicates the data objects identified in the data model and (ii) indicates the setting for the particular data object. The system provides a response based on output generated by the one or more AI/ML models in response to the request.

### CROSS-REFERENCE TO RELATED APPLICATIONS

This application claims the benefit of priority to U.S. Provisional Patent Application No. 63/696,720, filed on Sep. 19, 2024, the entire contents of which is incorporated by reference herein.

### BACKGROUND

The present specification relates to techniques for aggregation function control in data modeling using artificial intelligence.

### SUMMARY

In some implementations, a computer system provides functionality for aggregation function control in data modeling using artificial intelligence or machine learning (AI/ML) models, such as large language models (LLMs). The present techniques provide aggregation functionality by supporting non-aggregation flags and setting appropriate aggregation functions for data objects such as metrics, attributes, and fact metrics. The application and enforcement of a non-aggregation setting can operate at a back-end database management system, providing a check to avoid errors by large language models and other systems in handling data. The disclosed techniques allow users to designate specific metrics as non-aggregatable (e.g., non-aggregable, where aggregation is disallowed) in datasets or in associated data models or data schema. The system stores and uses these settings to enforce non-aggregation in the appropriate circumstances, and also to inform LLMs and other AI/ML models so that they do not improperly aggregate data types that should not be aggregated. This can prevent metrics that are designated as non-aggregatable from being subject to aggregation functions such as sum and average across different dimensions. As a result, data accuracy and relevant is improved in reports and dashboards, especially with metric values that are ratios, percentages, and other complex calculations where aggregated totals or average may be misleading or lack meaning.

The ability to mark metrics as non-aggregatable directly within datasets provides flexibility and accuracy in reporting. The present techniques thus improve the ability to handle complex, nuanced data scenarios. The system can support use cases such as financial analysis, ensuring accuracy in reports where averaging or summing metrics would result in incorrect interpretations, such as average interest rates over time. The system can support use cases such as healthcare reporting, by providing accurate patient data analysis where individual-specific metrics cannot be aggregated. The system can support use cases such as retail insights by enabling precise tracking of unique item-based metrics in sales data which should not be summed or averaged.

Different types of data can have different requirements for aggregation depending on the circumstances. Some types of data, such as percentages, rates, and ratios, should not be summed or added together or else they result in misleading results. Other types of data, even with simple integer values, are not appropriate to sum either. For example, a column of data may represent inventory levels of a product at a store, with a value for each day. This information can be very useful if shown in a graph to show the trend over time, or to find the inventory value on a particular day. However, if a user asks a question to a chatbot, such as “what is the total inventory for the store in 2023,” the chatbot may attempt to determine a “total” by summing the daily inventory values over the course of the year. This would not give a useful result, and would be very misleading by counting the same items maintained from day to day multiple times. For example, if there were typically about 10 items in inventory, the sum of daily inventory would be about 3650, even though this number has no meaningful relation to what the user intended. For example, the inventory may have fluctuated between 5 and 15 over the course of the year, and the total number of sales may be around 150. There is a risk that a chatbot or LLM would simply return the misleading sum as a “total” in answer to the user's question, leading to the user thinking that the inventory levels or sales at the store were orders of magnitude greater than they actually were.

Even when the user's question is not clear, the system can avoid confusing or misleading results by guiding AI/ML models and other applications to avoid improper aggregations. Further, the system can use a context-dependent approach that permits or allows aggregations across some dimensions but not others, and allows different aggregation functions to be set for different uses. For example, for daily store inventory values, a sum across a geographic dimension (e.g., across a region or across multiple store identifiers) may be allowed, since knowing the total inventory in a region (e.g., across multiple stores) is a useful and meaningful measure. However, the same daily store inventory metric can be blocked from aggregation across a time dimension measure (e.g., week, month, quarter, year, etc.) because summing daily inventory is not appropriate. In addition, or as an alternative, the system can store data that designates a different function for aggregation, such as taking the mean, that is appropriate over the time dimension. As a result, the system enables a fine-grained technique to specify specific aggregation functions and/or to block aggregation altogether in a context-dependent or selective way.

In one general aspect, a method performed by one or more computers includes: storing, by the one or more computers, a data model for one or more data sets, wherein the data model identifies a set of data objects in the one or more data sets; storing, by the one or more computers, a setting for a particular data object specifying whether the data object is aggregatable with respect to a particular dimension; receiving, by the one or more computers, a user prompt though a chatbot interface; providing, by the one or more computers, a request to one or more artificial intelligence and/or machine learning (AI/ML) models based on the user prompt, wherein the request (i) indicates the data objects identified in the data model and (ii) indicates the setting for the particular data object specifying whether the data object is aggregatable with respect to the particular dimension; and providing, by the one or more computers, a response to the user prompt based on output generated by the one or more AI/ML models in response to the request.

In some implementations, storing the setting comprises storing the setting in the data model.

In some implementations, storing the setting comprises storing the setting in an object definition for the particular data object that is stored in a semantic graph.

In some implementations, the setting specifies that the particular data object is non-aggregatable with respect to the particular dimension.

In some implementations, the method includes storing a second setting that specifies an alternative type of value to be provided instead of an aggregation of the particular data object.

In some implementations, the alternative type of value comprises a beginning value of a series, an ending value of the series, a maximum value of the series, or a minimum value of the series.

In some implementations, the particular dimension comprises time, date, location, geographical area, people, or products.

In some implementations, the method includes storing, for one or more of the data objects, data specifying one of a plurality of different aggregation functions to use for calculating aggregations of values for the one or more data objects.

In some implementations, the output generated by the one or more AI/ML models is used to send data processing instructions or a structured query language (SQL) statement to a database system, wherein the database system is configured to provide results while enforcing the setting for the particular data object.

In some implementations, the method includes providing the results to the one or more AI/ML models in a second request; and providing the response to the user prompt comprises providing text that the one or more AI/ML models generated based on the results from the database system.

In some implementations, storing the setting for the particular data object comprises storing (i) a first setting indicating that the particular data object is non-aggregatable with respect to a first dimension, and (ii) a second setting indicating that the particular data object is aggregatable with respect to a second dimension that is different from the first dimension.

In some implementations, the method includes storing a second setting that specifies, for one or more data values, (i) a first aggregation function to be used for a first dimension and (ii) a second aggregation function to be used for a second dimension, wherein the second aggregation function is different from the first aggregation function.

In some implementations, the set of data objects comprises a fact metric data object that combines characteristics of a fact data object with an ability for aggregation at a level of a data store or database, before retrieval of data values or transfer of data values from the data store or database over a network.

In some implementations, the method includes providing an instruction to retrieve data for the fact metric data object, wherein the instruction is for a data store or database to perform a filter operation or an aggregation of values of the fact metric data object and return the filtered or aggregated result instead of retrieving values in a column of data corresponding to the fact metric and a column of data for the filter operation or aggregation.

In some implementations, the fact metric data object specifies an order of operations to be performed for retrieving values of the fact metric, wherein the order of operations is different from a second order of operations used for facts or metrics, and wherein the order of operations involves a filter condition or aggregation to be applied by a data storage system or data storage service such that data retrieval transfers the filtered or aggregated result and does not transfer the unfiltered source data values for the fact metric.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram showing an example of a system for aggregation function control in data modeling using artificial intelligence.

FIGS. 2A-2C and 3 to 5 illustrate various user interfaces for aggregation function control in data modeling.

Like reference numbers and designations in the various drawings indicate like elements.

### DETAILED DESCRIPTION

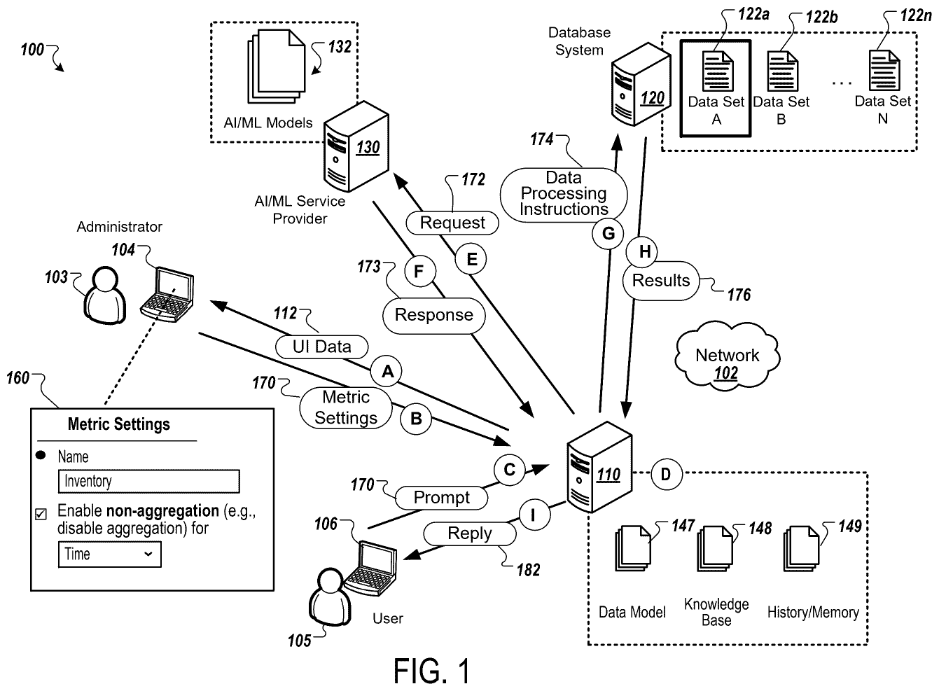

FIG. 1 is a diagram showing an example of a system for aggregation function control in data modeling using artificial intelligence. The system 100 includes a computer system 110, a database system 120, and an AI/ML service provider 130. The elements of the system 100 communicate over a network 102, such as the Internet.

In data processing systems, the ability to aggregate data can be very useful in providing answers to users' questions and providing information in a concise and accurate format. However, due to the semantic meaning of the data or the type of data (e.g., percentage or ratio), common aggregation functions such as an arithmetic sum are not appropriate and would provide inaccurate results. One area where this occurs is in reports, dashboards, or other documents, where result data in the report may be provided or grouped at one level, and applying certain types of aggregations from the result data would create erroneous or null values. In many of these cases, the correct aggregation would require going back to the underlying source data to apply a different aggregation function on the individual data values, such as to determine a mean or mode as a representation of a data series, rather than taking a sum. The subset of values in a report or other document may not include the values needed to make this calculation, and the aggregation for the metric would need to be executed against the data store or source data to return correct values. In some cases the type of data should not be aggregated at all over certain dimensions.

The system provides the ability to apply, save, and enforce limits on the aggregation functions that are allowed for individual metrics in a data set or data model. This can include specifying specific metrics in datasets to be as non-aggregatable. More specifically, the system can store and enforce parameters that control or limit aggregation of each individual metric on a dimension-by-dimension level. This can include allowing aggregation of a metric over one dimension (e.g., geography) and disallowing aggregation of the metric over a second dimension (e.g., time). Similarly, the system can designate the use of one aggregation function for a metric over one dimension (e.g., sum values across geography), but specify a different aggregation function for a second dimension (e.g., take an arithmetic mean of values across time). The system provides for controlling aggregation functionality of metrics so that metrics are aggregatable (e.g., aggregable, or permitted to be aggregated) across dimensions that result in meaningful, accurate results, and are non-aggregatable across dimensions that would result in inaccurate or irrelevant results. Non-aggregatable metrics are treated differently in the data model and user interface, preventing specified forms of aggregation. The non-aggregation function control is integrated with reporting and dashboard functionalities to correctly display and utilize the metrics. In addition, the system is configured to provide the aggregation settings (e.g., specifying the aggregation function and aggregation status for each dimension type) to AI/ML models such as LLMs to guide these models in also generating output that is accurate.

The system can specify provide interfaces for a user to review and set the aggregation functions used and the aggregation or non-aggregation status for metrics, for one or more dimensions. Marking a metric as a non-aggregatable metric can be made available to users in multiple different preparation workflows, regardless of entry point. Example entry points include entry from Dossier, create standalone dataset, and create dataset for chatbot. The system provides can provide user interface indicators (e.g., icons, color coding, formatting) to signal which metrics are non-aggregatable metrics. The present techniques decrease data analysis errors related to inappropriate metric aggregation.

In some implementations, the system can use a new data object type to improve efficiency in data processing. For example, the system can utilize a data object referred to as a fact metric in data models, where the fact metric combines characteristics of a fact with the ability for aggregation, when fact object types previously disallowed aggregations. Previously, many data processing systems represented metrics by creating (1) a fact data object in a data model or data schema, where the fact corresponded to a column of data and could not be aggregated, and (2) creating a separate metric data object based on the fact, where the metric was able to be aggregated. This arrangement provided a clear relationship and allowed for accurate processing, but sometimes led to inefficiencies.

For example, for a processing system to calculate an aggregation on a metric, the system would often request the entire set of values for the fact underlying the metric (e.g., the entire column of data) over a network from the database or data store, in order to process the entire column and generate the value for the corresponding metric. This can result in a large amount of data being transferred for each calculation, especially when the column or fact used to define the metric includes hundreds, thousands, or millions of values. This large transfer of data each time the metric aggregation is performed can use unnecessarily large amounts of network bandwidth, increase computation requirements, and increase latency. In addition, many data storage providers charge customers based on the amount of data transferred, resulting in high charges. As an example, for a typical metric defined based on an underlying fact, a dashboard or calculation may involve the application of a filter setting (e.g., limiting a set of records or rows to certain identifiers, a range of time, a range of geography, etc.) and then display the filtered results or perform a further aggregation on the filtered data. In the typical situation, the data processing system will retrieve the entire column of data from the data store over a network, then apply the filter locally, and then apply further aggregation as needed. This creates the inefficiency of transferring the entire column of data for the fact, as well as the delay of waiting until the data is received to begin further calculation.

To avoid this inefficiency, the system can define fact metrics with the ability to permit filtering and/or aggregation at an earlier level in the data flow, such as at the data store or database level, before further processing by the server or application that will use the data. For example, in the example where a filter and aggregation are to be applied, when an application (or document such as a report or dashboard) requests the value, the data model or data schema shows, due to the fact metric object type or other settings, that the filtering and/or aggregation can be performed at the data store or database. When allowed in this manner, the system requests the filtered and/or aggregated data, instructing the database system to apply the filter settings and/or aggregations, so that the database system transfers over the network the filtered and/or aggregated result, and does not need to transfer entire columns of data (e.g., a column for a fact and columns for any attributes used for filtering and aggregation). In cases such as determining a sum or mean for a set of data, the amount of data transferred can be reduced from thousands of values to a single result. Even in the case of simple filtering, the efficiency gained of transferring the filtered results rather than the unfiltered results can be significant.

Another way to consider the fact metric is that it can specify the order of operations performed when a server or application requests data processing. Instead of always starting with a full retrieval, and then applying filters, aggregations, and further processing, it allows a filter condition or other condition to be applied, and then data retrieval is performed to transfer the result set not the full unfiltered source data. To the user, the values are the same with a traditional metric or a fact metric, but the fact metric allows faster results with lower transfer sizes and lower costs. The status of a data object as a fact metric can alter how the data processing system generates structured query language (SQL) statements, to allow conditions like filter settings or aggregations to be performed by the data store or database system backend, rather than being performed after the data is retrieved over the network. In other words, the status of a data object as a fact metric, rather than a standard metric, can be a signal for the data processing engine to change the nature of the SQL statement being written and executed. The engine selectively applies different functions or operations to express a condition depending on the type of data object (e.g., fact metric, metric) specified in the data model.

The designation of a data object as a fact metric can thus enable the system to specify a set of data as one that is able to be aggregated and/or filtered natively at the data store or database system, so the system can return the aggregation result, and not the entire set of underlying source data from which the calculation would be performed. The fact metric data object, which serves as a hybrid with some characteristics of facts and some of metrics, also simplifies and streamlines the data model or data schema itself, allowing a single object where two were previously required.

A fact metric can have a default aggregation function specified within its definition in the data model or data schema. To assist users in viewing and changing this aggregation function, the system can provide a user interface that has a menu for assigning properties (e.g., settings, parameter values, usage limits) to the fact metric. The menu can provide an option to enable non-aggregation (e.g., to disable aggregation) for the fact metric. The non-aggregation setting can be applied across all dimensions or can be made specific to one or more particular dimensions, such as time (e.g., hours, days, months), location (e.g., geographic region), or category (e.g., product type). The non-aggregation setting can be specified for all types of aggregation or can be specific to particular types of aggregation (e.g., Average, Sum, Count). As a result, the system allows users to fine-tune the aggregation behavior of metrics and fact metrics for each of various dimensions with respect to each of various aggregation functions.

The example of FIG. 1 includes stages (A) to (I), which represent various operations and a flow of data, and which can occur in the order illustrated or in a different order. Stages (A) to (I) show an example of metric settings being defined for a metric of a data model. The data model is then used to generate a reply 182 to a prompt 170 received from a user 105.

The computer system 110 can be implemented using one or more servers, including one or more cloud computing systems. For example, the computer system 110 can be an application server. The computer system 110 provides front-end functionality to interface with various client devices. For example, the computer system 110 can provide an interface for creating and editing data models and other interactive applications that leverage AI/ML models. The interface can be an application programming interface (API), a user interface (e.g., by providing user interface data for a web page or web application), or another type of interface. As discussed further below, the computer system 110 performs various other functions to generate and save data models.

The database system 120 can provide various data retrieval and processing functions. For example, the database system 120 can be a database management system (DBMS), and can include the capability to process operations specified in SQL, Python code, or in other forms. The database system 120 has access to various data sets 122a-122n, which can be private data sets for organization, such as a company. The database system 120 can store and use data sets in any of various forms such as tables, data cubes, or other forms. The data sets can include, for example, .csv files, .xlsx files, unstructured data, data from SaaS platforms (e.g., Shopify, Google analytics), cloud sources (e.g., Snowflake, Databricks, Redshift), or any combination thereof.

The AI/ML service provider 130 can be a server system or cloud computing platform that provides access to one or more AI/ML models 132, such as LLMs. The computer system 110, the database system 120, and the AI/ML service provider 130 may be implemented as separate systems or may be integrated in a single system. For example, the AI/ML service provider 130 can be a third-party service or can be managed and operated by the same party as the computer system 110 and/or the database system 120.

As an overview, the computer system 110 interacts with a client device 104 of an administrator 103 to receive customization data that indicates customizations for objects of a data model. The computer system 110 then coordinates processing to generate and provide answers to questions and other user prompts received from user devices. To customize object settings, an administrator 103 interacts with the computer system 110 to specify the settings for one or more objects (e.g., facts, attributes, metrics, fact metrics) of the data model 147. The computer system 110 saves the settings specified by the administrator 103 in the data model 147.

In stage (A), the computer system 110 provides user interface data 112 to the client device 104 over the network 102. To provide the interface, the computer system 110 can provide data for a web application, web page, or native application that, when rendered on the client device 104, provides the functionality to specify settings of the objects. For example, the computer system 110 can provide content of a web page or web application for creating or editing the data model objects. The user interface data 112 is rendered on the display of the client device 104, represented by user interface 160.

The user interface 160 provides controls to specify different properties of the data model. For example, the user interface 160 enables the administrator 103 to specify default aggregation and/or non-aggregation settings for data objects.

In stage (B), the administrator 103 interacts with the user interface 160 to enter settings for a data object such as a metric or fact metric. The client device 104 sends metric settings 114 to the computer system 110 over the network 102. The computer system 110 then saves the settings in the data model 147 that is being edited or used.

The system enables a variety of different aggregation settings to be specified, saved, and enforced. For example, a setting to allow or disallow aggregation can be stored for each metric. More specifically, the setting can allow or disallow aggregation for each individual dimension of multiple dimensions (e.g., time, geography, category, etc.). In some implementations, many data objects in a data model can serve as elements over which aggregation can take place, including some or all attribute data objects and potentially some metrics, fact metrics, or other object types. If desired, for each metric or fact metric, the aggregation or non-aggregation setting can be defined for each of the attributes or other data objects in a data model, in addition to or instead of by dimensions. The aggregation settings can also include specifying a particular aggregation function to be used (e.g., sum, mean, median, mode, geometric mean, etc.), and the aggregation function can be specified for each dimension or for each attribute or other data object across which aggregation might be requested.

As an example, the administrator 103 selects to enable non-aggregation behavior for a fact metric of “Inventory.” The administrator 103 selects to enable the non-aggregation behavior for a dimension of “Time.” The user input marks the Inventory metric as non-aggregatable over dimensions of time. In some implementations, the user can specify non-aggregation over one or more specific units of time (e.g., hour, day, week, month, year). In an example in which the metric should not be aggregated over location, the user input can enable non-aggregation behavior for “location,” or can specify non-aggregation over one or more specific units of location (e.g., city, county, country, continent).

The process of specifying settings for the data objects can be iterative, with potentially multiple rounds of the administrator 103 interacting with the user interface 160 to incrementally adjust the settings of the data model 147.

The data model 147 can include information about the data set(s) 122a-122n, without including actual data from the data set. For example, the data model 147 can include a data schema for the data set 122a. In general, the data model 147 can indicate a list of logical objects represented in the data set 122a, such as a list of the elements or components of the data set. For example, the data model 147 can indicate that the data set 122a includes logical objects such as date, customer identifier, country code, product name, and so on. These data objects can represent quantities or data objects that are represented in, or can be derived from, data in the data set 122a. The logical objects, such as metrics, fact metrics, or attributes, can represent the type of data that is stored in or derived from a column of data. For example, an attribute may represent a type of data stored in a column of a data table or the result that would be obtained by applying a particular arithmetic expression to data in a column. Similarly, a metric or fact metric can represent the result of applying a particular aggregation function or other operation(s) to values in one or more columns of a data table. Accordingly, the data model 147 can indicate the attributes, metrics, and fact metrics that are available for the AI/ML model 132 to work with, and potentially additional attributes, metrics, or fact metrics that can be generated or operations that are available for the database system 120 to create a new attributes, metrics, or fact metrics.

In some cases, the data model 147 can indicate, through the logical objects identified, types of data from tables, columns, and other elements that make up the data set 122a, in addition to or instead of the semantic meanings and/or relationships among these elements of the data set 122a.

The data model 147 can indicate the names or labels for data objects, classifications of the objects (e.g., metric, attribute, fact metric, etc.), and other information. The data model 147 can store metadata for the data objects. For example, the data model 147 can store settings for a data object such as whether the data object is nonaggregatable over certain dimensions and/or certain types of aggregation. In some implementations, some or all of the data model 147 can be stored in a semantic graph or other metadata repository.

In some implementations, the data model 147 can include sample data for the data set 122a, such as a sampling of data from the data set 122a. The sample data can be fictitious example data that may be artificially synthesized to be representative of the data in the data set 122a (e.g., similar types of data), without indicating actual contents of the data set 122a. The data model 147 can be provided in any of various forms, such as a database schema from a database management system, a list or definitions of objects, components, or identifiers of the data set 122a, etc.

The knowledge base 148 can provide a mapping for the AI/ML model 132 to map words and phrases with non-standard or idiosyncratic meanings (e.g., jargon, nicknames, etc.) to definitions, descriptions, or other indications of their meaning. The knowledge base 148 can include information determined at any of multiple levels, such as at the level of an enterprise as a whole, for a department or group of individuals, or for a specific individual. Similarly, the knowledge base 148 can be one that has been created for a single chatbot or AI/ML application or one that is shared with multiple chatbots or AI/ML applications.

In some implementations, the computer system 110 enables the administrator 103 to attach one or more additional data sets to adjust the operation and output of the chatbot. For example, an additional data set can be a knowledge base 148 or data dictionary can be added. Unlike the primary data set that the user selects for the chatbot (e.g., data set 122a), the chatbot is not configured to answer questions about the additional data set or to retrieve metrics or to provide visualizations of the knowledge base 148. Instead, the knowledge base 148 can be provided to assist the chatbot in interpreting user queries and providing responses with the terminology for the user's organization. In general, the knowledge base 148 can function to provide contextual knowledge to the AI/ML models 132, so the models can classify and use the nomenclature of the end user when generating answers to user prompts.

Many different organizations or departments use terms that have a special contextual meaning, or are not part of general language, and so would not be available for training of an LLM. For example, a company may internally use various names for its products, projects, teams, locations, policies, initiatives, organizational structure, and so on. For example, a company be developing a product with a codename of “starfish” that being developed by a group of employees called “red team.” The training state of an LLM would not incorporate information about these entities, which are specific to the company and not referenced in public documents. To enable the chatbot to process questions about these internal entities and provide answers that reference them, a knowledge base 148 is designated for the chatbot to describe these and other internal terms. Each time the user submits a prompt, the knowledge base 148 can be provided to assist the LLM with the context that is appropriate for the company. The knowledge base 148 can provide information similar to a semantic graph, by describing entities and their relationships. In some cases, the information in the knowledge base 148 can be derived from a semantic graph 150 and then converted into text (e.g., unstructured, semi-structured, or structured) in a format that can be processed by the LLM.

In general, the knowledge base 148 or other additional data set can include data that maps terms or phrases to their meanings. In many cases, this can include semi-structured data or explanatory content, as a way to explain entities and relationships to the AI/ML models 132. Although the knowledge base 148 may include definitions, more generally the information may include descriptions of people, roles, business units, products, and other terms that may be referenced. The administrator 103 may upload one or more of additional data sets and specify which additional data sets, if any, should be used to provided context for a chatbot. The data sets selected for this contextual function can then be used to provide context for all prompts and responses of the chatbot.

In some implementations, the contextual data sets or knowledge bases can be applied so that they apply to multiple chatbots. For example, an enterprise can designate one or more knowledge bases 148 as contextual data sets that can be applied consistently across the enterprise, for all chatbots created and used in the enterprise. Similarly, different departments within the enterprise may add their own particular contextual data sets that may supplement the enterprise-wide knowledge bases 148. In addition, specific contextual data sets can be added for specific chatbots. In this way, chatbots at different levels of an organization can inherit a consistent set of terminology and knowledge in an organization, which also makes maintaining the overall knowledge base much simpler. The knowledge base 148 can additionally or alternatively be specified with a scope that corresponds to a computing environment, so that chatbots associated with a particular domain or server inherit the knowledge bases for that domain or server.

One of the advantages of the knowledge base 148 is consistency for many users and even for many different chatbots of an organization. The user submitting a prompt does not need to take any action to select or include the knowledge base 148 in the chatbot's processing, the chatbot automatically include the knowledge base 148 in its context for each prompt or question received. Also, because the knowledge base 148 can be shared or inherited by many chatbots within an organization, updating and maintaining the knowledge base 148 is simple. An edit to the knowledge base 148 is automatically applied to all of the chatbots associated with the organization, even if the chatbots were created by different administrators or provided to different sets of users.

In addition, the knowledge base 148 provides persistent context that is not lost from one prompt to another or from one session to another. The knowledge base content can also be implemented applied in a manner that the knowledge base 148 does not count toward the instruction token limits that the AI/ML models 132 consume for each response. Rather than counting toward the tokens for prompts and recent history, the knowledge base 148 can be accessed or provided to the AI/ML models 132 as a separate source of knowledge apart from the prompt and context, and so does not count toward the token limits of an LLM. Implementations of access to the knowledge base 148 can vary. For example, when a session with the chatbot is instantiated, the knowledge base can be provided as part of initializing the chatbot. In some cases, the AI/ML models 132 are additionally or alternatively configured to access the primary dataset and if the user prompt includes a term or makes a request for an item not specified in the primary dataset, the chatbot is configured for the AI/ML models 132 to then check the knowledge base or other contextual data sets. In some implementations, the knowledge base 148 can be prepared as an embedding, a vector database, or other format that can be accessed by or referred to by the AI/ML models 132.

The history or memory 149 can represent any of various types of information that can be stored external to the AI/ML models 132 but captures information about previous sessions, previous conversations or previous text of the current conversation, preferences of one or more users, learning from feedback of one or more users, and so on. In some implementations, the chatbot is designed to have a long-term memory 149, which can store information learned from users in past interactions. For example, LLMs and other AI/ML models 132, on their own, are generally stateless and do not natively understand the user context or history of interactions with the user, especially from previous sessions. The computer system 110 can facilitate learning by the chatbot to provide infrastructure that creates a long-term memory 149 for the chatbot. For example, the long-term memory 149 can store items such as definitions of terms for a particular user context, unique text elements the chatbot might encounter, and feedback from prior user interactions.

One valuable aspect of the long-term memory 149 is the ability for the chatbot to learn and adapt from explicit or implicit user feedback over time. If a user asks questions, then gives feedback they were expecting something different (e.g., either through text of a prompt to the chatbot or through an external survey or rating), then the computer system 110 can capture that feedback and update the chatbot to better provide what the user intended in the future. For example, the computer system 110 may add or adjust the instructions to the chatbot to reflect the user expectations or preferences. In some cases, this may include changing the default response format or response instructions, or may include adding rules or explanations that are context-dependent (e.g., apply to specific phrases or prompt types). This learning may occur at different levels. For example, it may include learning that particular terms, phrases, or combinations of terms call for a particular type of response. As another example, the feedback may more shift answers generally in certain ways, e.g., to be more verbose, more concise, to add or change visualizations, to change the order of content, to add or adjust summary elements, and so on.

The learning of the chatbot is managed by the computer system 110 and happens on an ongoing basis as users interact with the chatbot. The information learned is stored outside the LLM or other AI/ML models 132, and is stored in the long-term memory 149 designated for the chatbot. Each chatbot that is created can have its own long-term memory 149, which is updated by the interactions of its own users. Before the computer system 110 asks the stateless LLM to provide a response to a user prompt, the computer system 110 facilitates retrieval of data from the long-term memory 149, potentially to provide customized instructions or additional contextual data to accompany the user prompt and tailor the response based on what has been learned from prior interactions. The long-term memory 149 thus provides better reference data for LLM to use in guiding answer generation.

The long-term memory 149 can include business definitions of other users have specified or uploaded. In this way, the long-term memory 149 can supplement or expand on the descriptions provided in the knowledge base 148. The information can be stored and used at different levels, e.g., at the level of individual users, at the level of a department or group of users, and for an enterprise as a whole. In other words, the preferences of an individual may be learned and applied for that individual. In addition, the aggregate preferences learned for many individuals can be combined to also adjust the chatbot, to accelerate the adaptation of the chatbot to meet the needs of the user base. In some implementations, the computer system 110 can use access control lists and permissions for users to apply security policies to adjust access and appropriately set the context for each user.

Components of the computer system 110 can be provided as one or more computer executable software modules or hardware modules. That is, some or all of the functions of components of computer system 110 can be provided as a block of computer code, which upon execution by a processor, causes the processor to perform functions described below. Some or all of the functions of components of the computer system 110 can be implemented in electronic circuitry, e.g., by individual computer systems (e.g., servers), processors, microcontrollers, a field programmable gate array (FPGA), or an application specific integrated circuit (ASIC).

Components of the computer system 110 can include one or more machine learning models and/or can access one or more machine learning models. For example, components of the computer system 110 can access AI/ML models 132 hosted by the AI/ML service provider 130. In some implementations, components of the computer system 110 include machine learning models. As described above, the computer system 110 access the AI/ML models 132 provided by the AI/ML service provider. The AI/ML models 132 can be supplemented by additional information such as data stored in a knowledge base 144 and/or a long-term memory 149.

In some implementations, the data model 147 is used by an Al chatbot to generate answers to user questions. The user 105 can submit queries to the chatbot through the client device 104, and the chatbot can execute the queries using the data in the data model 147, and provide the query responses to the user 105 through the client device 104.

For example, at stage (C), the user 105 enters a prompt 170 through user device 106, and the prompt 170 is sent to the computer system 110 over the network 102. The user device 106 can display a chatbot interface which can be a web page, a web application, a native application, or other functionality. The prompt 170 can include, for example, a request for total inventory numbers, such as “Show me the total inventory for 2024.”

At stage (D), the computer system 110 generates a request 172 to the AI/ML service provider 130, requesting for an AI/ML model 132 to generate code or instructions for retrieving data for responding to the prompt 170. For example, the request 172 can include text such as, “Generate a SQL statement that will produce result data that answers the prompt ‘Show me the total inventory for 2024’.” The request 172 can thus include or be based at least in part on the user's prompt 170. In the example, the computer system 110 does not request for the AI/ML model 132 to provide data values. Instead, the request 172 asks for code or instructions that, when executed, would retrieve and/or calculate the data for responding to the prompt 170. For example, the request 172 asks for the AI/ML model 132 to provide instructions in a standardized format, such as a SQL statement, that specifies a portion of the data set 122a to be retrieved and/or operations to calculate values from that data.

The request 172 to the AI/ML model 132 can include the data model 147 or can at least include the relevant data object settings or definitions in the context of the request 172. By providing the content of the data model 147 to the AI/ML model 132, the computer system 110 can guide the processing of the AI/ML model 132 and avoid misleading or inaccurate results. For example, because the administrator 103 previously specified the “Inventory” metric to be non-aggregatable, the metric definition (e.g., metric properties, settings, description, etc.) for this metric specifies to the AI/ML model 132 that an aggregation (or at least a sum operation over the dimension of time) should not be applied to the “Inventory” metric. The request 172 can instruct the AI/ML model 132 to apply and enforce the limits set in the object definition settings, so that when the AI/ML model 132 generates output (e.g., SQL statement, Python code), the output avoids performing disallowed operations. This helps provide more accurate and usable results, even when the user provides vague or incomplete questions.

For example, the user's request for “total inventory” would typically be interpreted by an LLM as requesting a sum of the values for the “Inventory” data object, and the user has specifically called for a total or aggregation over time. Nevertheless, because the AI/ML model 132 receives the data model 147, or at least the object definition for the “Inventory” metric, the AI/ML model 132 has the settings that specify that the “Inventory” metric should not be aggregated over time. Based on the data model 147 information, the AI/ML model 132 can select a different measure, such as the minimum and maximum values of the “Inventory” metric over the user's specified time range, the characteristics for the range of values of the “Inventory” metric of the time range, an average (e.g., mean, median, mode, etc.) of the “Inventory” metric of the time range, and so on. The data model 147 may specify these as alternative measures to provide in place of a typical aggregation or sum. For example, the data model 147 may indicate to provide an average instead of a sum when an aggregation is requested over time. Alternatively, the data model 147 may simply specify that no aggregation over time is permitted, and that the AI/ML model 147 should return general statistics or return an error message or request clarification from the user. As an example, the data model 147 or general instructions to the AI/ML model 147 can specify that, for a metric that is non-aggregatable over time (or over another dimension), that instead of an aggregation the beginning value or ending value of the range should be used.

At stage (E), the computer system 110 sends the request 172 to the AI/ML service provider 130. The request 172 can ask the AI/ML model 132 to provide instructions for retrieving data for responding to the user prompt, “Show me the total inventory for 2024.” Although the prompt asks for total inventory, a sum of total inventory over a year is not a meaningful indicator. The data model 147 content provided with the request 172, and potentially instructions to the AI/ML model 132 to enforce the non-aggregation limits specified in the data model 147, can cause the AI/ML model 132 to generate output that avoids improper aggregation.

In some implementations, the computer system 110 may analyze the user's question to detect when an improper aggregation is requested, and can include the result of this check in the request 172. The computer system 110 can include in the request 172 a specific instruction to the AI/ML service provider 130 not to aggregate the Inventory metric over the time dimension, according to the non-aggregation settings. However, in many cases, it can be more efficient and simpler to simply provide the data model 147 content, including the aggregation or non-aggregation settings, and instruct the AI/ML model 132 to generate output that follows or is consistent with those settings.

Thus, to prevent inappropriate metric aggregation, the request 172 can include the settings for the metric “Inventory,” including the designation of the metric as being non-aggregatable over the time dimension. In some implementations, to prevent inappropriate metric aggregation, the request 172 asks the AI/ML service provider 130 to determine whether the prompt involves a time dimension, and if so, not to aggregate the inventory metric over the time dimension. In some implementations, to prevent inappropriate metric aggregation, the request 172 sent to the AI/ML service provider 130 specifies a dimension for which the metric of Inventory is permitted to be aggregated over. For example, the request 172 can specify that the Inventory is permitted to be aggregated over a location dimension. The AI/ML model 132 can determine that the prompt 170 is related to time, but that the Inventory metric is only permitted to be aggregated over the location dimension. Therefore, the response 173 can include code or instructions that aggregate over location, but not time.

In some implementations, to prevent inappropriate metric aggregation, the request 172 sent to the AI/ML service provider 130 includes an instruction that the metric of Inventory is not to be aggregated using particular types of aggregation, as specified in the definition of the metric. For example, the metric may be non-aggregatable using a summation function, but may be aggregatable using an average function. These settings may be specific to a particular dimension, such as time. In some implementations, to prevent inappropriate metric aggregation, the request 172 includes the settings for the metric “Inventory,” including the designation of the metric as being non-aggregatable using the particular types of aggregation.

At stage (F), the AI/ML service provider 130 uses one or more of the AI/ML models 132 to generate a response to the request 172. The AI/ML service provider 130 then sends the response 173, which may include code or instructions for retrieving or processing data, to the computer system 110. For example, the AI/ML service provider 130 uses the AI/ML models 132 to generate, as the response 173, a SQL statement that, when executed by the database system 120, will retrieve and/or generate the data needed to answer the prompt 170 based on the data set 122a. The response 173 can be expressed in any of a variety of ways, such as one or more SQL statements, as executable or interpretable code, such as Python code, as a list of API calls or commands to be executed, and so on. The response 173 can provide instructions for retrieving specific portions of one or more data sets, such as from the specific data set 122a specified in the prompt 170 or otherwise indicated to the AI/ML model 132 used. The response 173 can additionally or alternatively instruct various data processing steps or operations to be performed, including data joins, data aggregations, filtering data, evaluating expressions, creating new metrics and calculating their values, etc.

In some implementations, the computer system 110 evaluates the response 173 to determine whether the code or instructions specify any improper aggregation. For example, the computer system 110 can compare the code or instructions to the non-aggregation behavior defined by the Inventory metric. In an example, the code or instructions may instruct to sum a “month” column of data from January to December 2024. The computer system 110 can determine that the sum of the “month” column of data is an improper aggregation according to the non-aggregation settings of the Inventory metric.

In response to determining that the code or instructions included in the response 173 would cause improper aggregation, the computer system 110 can send a supplemental request to the AI/ML service provider 130 asking for an updated response that does not cause improper aggregation. In response to determining that the code or instructions included in the response 173 would not cause improper aggregation, the computer system 110 can proceed to retrieve data using the code or instructions.

At stage (G), the computer system 110 sends data processing instructions 174 to the database system 120, to instruct the database system 120 to retrieve the data needed to respond to the prompt 170. The data processing instructions 174 can include the response 173, or can include a modified version of the response 173, such as a version that has been converted or translated to a different form for processing by the database system 120.

At stage (H), the database system 120 retrieves and/or calculates a set of results 176 based on the data processing instructions 174 and sends those results 176 to the computer system 110. For objects that are metrics, the database system 120 may retrieve an entire data table and/or dataset in order to perform the specified calculations. For objects that are fact metrics with default aggregation, the database system 120 is able to retrieve a smaller amount of data (e.g., a single row of data) due to the default aggregation being defined within the fact metric. Thus, for calculations performed using fact metrics, calculations can be performed by accessing smaller amounts of data. As a result, the use of fact metric objects improves efficiency for performing database processing operations. The database system 120 also enforces the aggregation or non-aggregation settings specified for each data object. As a result, even if the data processing instructions 174 specify to aggregate a data object over a dimension specified as non-aggregatable in the definition of the data object, the database system 120 will omit an answer or provide an alternative type of value (e.g., first in the data series, last in the data series, etc., as specified in advance in the data object definition).

At stage (I), the computer system 110 generates and sends a reply 182 to the user device 106 over the network 102, in response to the user prompt 170 “Show me the total inventory for 2024.” The reply 182 can include, for example, a visualization of the results 176. Because the Inventory metric is non-aggregatable over time, the visualization will not show a total inventory summed over the year 2024. Instead, the visualization may show incremental inventory totals or averages (e.g., a bar chart or ATTORNEY graph showing these items by day, week month, or other time unit). The reply 182 can include a summary of the results 176.

As another example, the computer system 110 can send the user prompt 170 and the results 176 to the AI/ML model 132 in a second request, and ask that the AI/ML model 132 generate a text response to the user prompt 170 using the results 176. The AI/ML model 132 can generate text output that describes features of the results 176, such as maximum or minimum values of Inventory over the specified range, a table or list of the highest and/or lowest Inventory values, and so on.

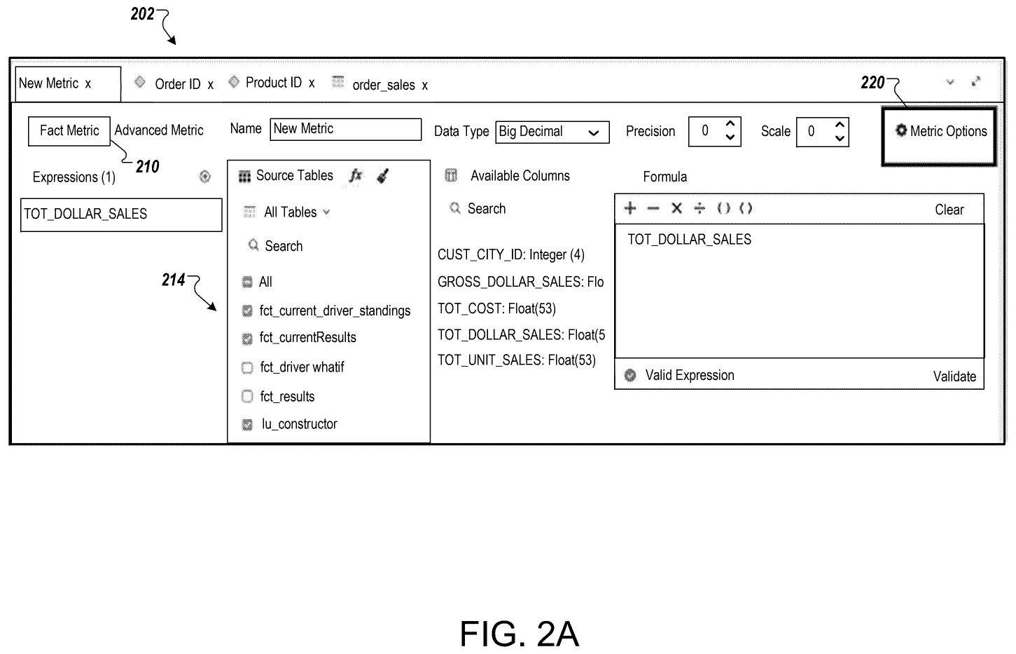

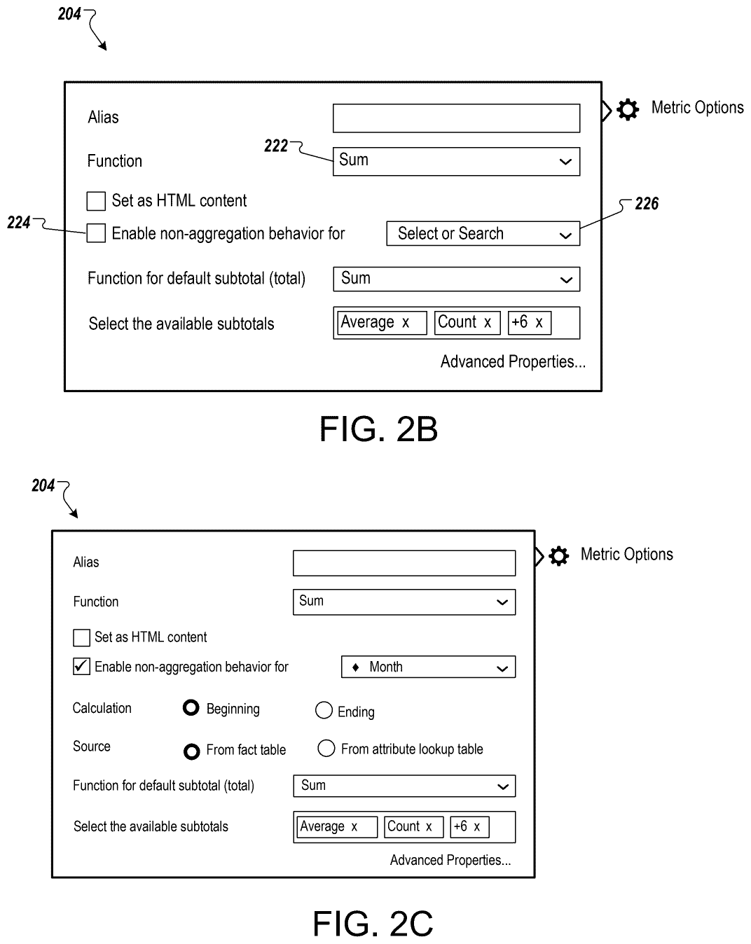

FIGS. 2-5 illustrate various user interfaces for illustrate various user interfaces for aggregation function control in data modeling. The user interfaces can be presented by a display such as a display of the client device 104 of the system 100.

FIG. 2A shows an example user interface 202 for configuring settings of a data object. Specifically, the user interface 202 presents options for creating a new metric. The object type of the new metric is a Fact Metric 210. The user interface 202 includes a window 214 for selecting source tables for the new metric. The user interface 202 includes a selectable icon 220 for selecting Metric Options.

FIG. 2B. shows an example window 204 of a user interface for configuring settings of a data object. The user window 204 can be presented in response to user selection of the icon 220. The window provides a field 222 for selecting a Function for the Fact Metric. Example functions include Average, Count, First, Geographic Mean, Last, Maximum, Median, Minimum, Mode, Product, Standard Deviation, Sum, and Variance.

Average is the sum of input values divided by the number of input values. Count is the number of distinct input values. Geometric Mean is the square root of the product of input values. Median is the middle value when input values are sorted. Mode is the most frequently found input value. Standard deviation is the statistical distribution of input values. Variance is the square of the standard deviation of input values.

The window 204 includes a selectable icon 224 for enabling non-aggregation behavior, and a field 226 for inputting a type of the non-aggregation behavior. The type of the non-aggregation behavior can be, for example, a dimension over which the Fact Metric is not to be aggregated.

FIG. 2C shows the example window 204 expanded to show non-aggregation behavior options. The non-aggregation behavior options are presented in the window 204 in response to selection of the icon 224. The non-aggregation options include options for selecting a Calculation and a Source. The menu provided in the window 204 allows marking a metric as non-aggregatable. By default, non-aggregatable metrics use Fact Ending grouping, with the source from a fact table. The system provides an option to set Fact Beginning grouping, and an option to set the source form an attribute lookup table. A Fact Ending grouping takes values from a beginning of a dimension (e.g., a beginning of a time interval) instead of summing across the dimension. A Fact Beginning grouping takes values from an ending of a dimension (e.g., an ending of a time interval) instead of summing across the dimension.

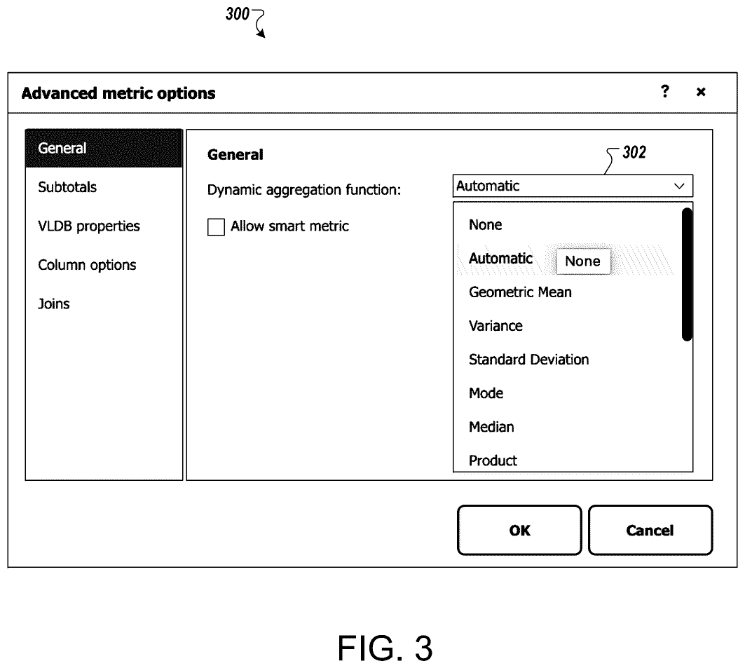

FIG. 3 shows an example user interface 300 for inputting advanced metric options. The advanced metrics options include setting a dynamic aggregation function for a metric. The user interface 300 includes a field 302 for selecting the dynamic aggregation function. Example aggregation functions include Geometric Mean, Variance, Standard Deviation, Mode, Median, and Product. The dynamic aggregation function can be assigned to a metric to create a fact metric, which is metric that has a default aggregation within the definition of the metric.

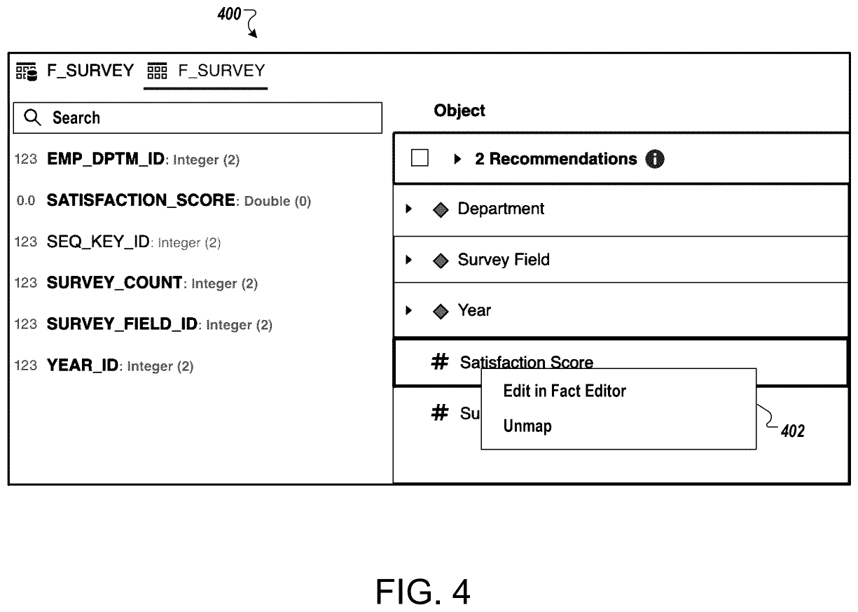

FIG. 4 shows an example user interface 400 for editing data objects. Upon selection of the object “Satisfaction Score,” the user interface 400 presents a pop up window 402 showing options of: “Edit in Fact Editor” and “Unmap.” The user can select to editing the object in fact editor in order to change properties of the object. Properties can include aggregation settings for the object. The user can select to unmap the object in order to change the object to an unmapped column within the data model.

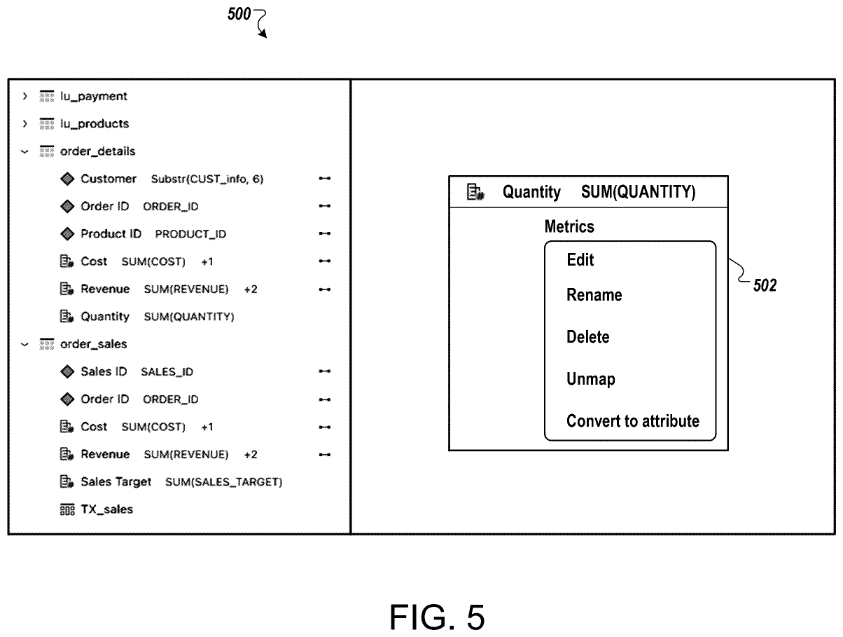

FIG. 5 shows an example user interface 500 for editing data objects. The user interface 500 includes a window 502 showing options for modifying the Metric “Quantity.” The window 502 shows options of: “Edit,” “Rename,” “Delete,” “Unmap,” and “Convert to attribute.” Selection of “Edit” results in opening the metric editor in order to change properties of the metric. Selection of “Rename” enables the user to rename the metric. Selection of “Delete” enables the user to delete the metric or fact metric completely. Selection of “Convert to attribute” enables the user to change the fact metric to an attribute within the data model.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them.

Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims can be performed in a different order and still achieve desirable results.

1. A method performed by one or more computers, the method comprising:
storing, by the one or more computers, a data model for one or more data sets, wherein the data model identifies a set of data objects in the one or more data sets;
storing, by the one or more computers, a setting for a particular data object specifying whether the data object is aggregatable with respect to a particular dimension;
receiving, by the one or more computers, a user prompt though a chatbot interface;
providing, by the one or more computers, a request to one or more artificial intelligence and/or machine learning (AI/ML) models based on the user prompt, wherein the request (i) indicates the data objects identified in the data model and (ii) indicates the setting for the particular data object specifying whether the data object is aggregatable with respect to the particular dimension; and
providing, by the one or more computers, a response to the user prompt based on output generated by the one or more AI/ML models in response to the request.

2. The method of claim 1, wherein storing the setting comprises storing the setting in the data model.

3. The method of claim 1, wherein storing the setting comprises storing the setting in an object definition for the particular data object that is stored in a semantic graph.

4. The method of claim 1, wherein the setting specifies that the particular data object is non-aggregatable with respect to the particular dimension.

5. The method of claim 4, further comprising storing a second setting that specifies an alternative type of value to be provided instead of an aggregation of the particular data object.

6. The method of claim 5, wherein the alternative type of value comprises a beginning value of a series, an ending value of the series, a maximum value of the series, or a minimum value of the series.

7. The method of claim 1, wherein the particular dimension comprises time, date, location, geographical area, people, or products.

8. The method of claim 1, comprising storing, for one or more of the data objects, data specifying one of a plurality of different aggregation functions to use for calculating aggregations of values for the one or more data objects.

9. The method of claim 1, wherein the output generated by the one or more AI/ML models is used to send data processing instructions or a structured query language (SQL) statement to a database system, wherein the database system is configured to provide results while enforcing the setting for the particular data object.

10. The method of claim 9, comprising providing the results to the one or more AI/ML models in a second request;
wherein providing the response to the user prompt comprises providing text that the one or more AI/ML models generated based on the results from the database system.

11. The method of claim 1, wherein storing the setting for the particular data object comprises storing (i) a first setting indicating that the particular data object is non-aggregatable with respect to a first dimension, and (ii) a second setting indicating that the particular data object is aggregatable with respect to a second dimension that is different from the first dimension.

12. The method of claim 1, comprising storing a second setting that specifies, for one or more data values, (i) a first aggregation function to be used for a first dimension and (ii) a second aggregation function to be used for a second dimension, wherein the second aggregation function is different from the first aggregation function.

13. The method of claim 1, wherein the set of data objects comprises a fact metric data object that combines characteristics of a fact data object with an ability for aggregation at a level of a data store or database, before retrieval of data values or transfer of data values from the data store or database over a network

14. The method of claim 13, comprising providing an instruction to retrieve data for the fact metric data object, wherein the instruction is for a data store or database to perform a filter operation or an aggregation of values of the fact metric data object and return the filtered or aggregated result instead of retrieving values in a column of data corresponding to the fact metric and a column of data for the filter operation or aggregation.

15. The method of claim 13, wherein the fact metric data object specifies an order of operations to be performed for retrieving values of the fact metric, wherein the order of operations is different from a second order of operations used for facts or metrics, and wherein the order of operations involves a filter condition or aggregation to be applied by a data storage system or data storage service such that data retrieval transfers the filtered or aggregated result and does not transfer the unfiltered source data values for the fact metric.

16. A system comprising:
one or more computers; and
one or more computer-readable media storing instructions that are operable, when executed by the one or more computers, to perform operations comprising:
storing, by the one or more computers, a data model for one or more data sets, wherein the data model identifies a set of data objects in the one or more data sets;
storing, by the one or more computers, a setting for a particular data object specifying whether the data object is aggregatable with respect to a particular dimension;
receiving, by the one or more computers, a user prompt though a chatbot interface;
providing, by the one or more computers, a request to one or more artificial intelligence and/or machine learning (AI/ML) models based on the user prompt, wherein the request (i) indicates the data objects identified in the data model and (ii) indicates the setting for the particular data object specifying whether the data object is aggregatable with respect to the particular dimension; and
providing, by the one or more computers, a response to the user prompt based on output generated by the one or more AI/ML models in response to the request.

17. The system of claim 16, wherein storing the setting comprises storing the setting in the data model.

18. The system of claim 16, wherein storing the setting comprises storing the setting in an object definition for the particular data object that is stored in a semantic graph.

19. The system of claim 16, wherein the setting specifies that the particular data object is non-aggregatable with respect to the particular dimension.

20. One or more non-transitory computer-readable media storing instructions that are operable, when executed by the one or more computers, to perform operations comprising:
storing, by the one or more computers, a data model for one or more data sets, wherein the data model identifies a set of data objects in the one or more data sets;
storing, by the one or more computers, a setting for a particular data object specifying whether the data object is aggregatable with respect to a particular dimension;
receiving, by the one or more computers, a user prompt though a chatbot interface;
providing, by the one or more computers, a request to one or more artificial intelligence and/or machine learning (AI/ML) models based on the user prompt, wherein the request (i) indicates the data objects identified in the data model and (ii) indicates the setting for the particular data object specifying whether the data object is aggregatable with respect to the particular dimension; and
providing, by the one or more computers, a response to the user prompt based on output generated by the one or more AI/ML models in response to the request.
